(19) United States
(12) Patent Application Publication
(10) Pub. No.: US 2015/0154802 A1
(43) Pub. Date: Jun. 4, 2015

(54) AUGMENTED REALITY LANE CHANGE ASSISTANT SYSTEM USING PROJECTION UNIT

(71) Applicant: HYUNDAI MOBIS Co., Ltd., Yongin-si (KR)

(72) Inventor: Ki Hyuk SONG, Yongin-si (KR)

(21) Appl. No.: 14/554,127

(22) Filed: Nov. 26, 2014

(30) Foreign Application Priority Data
Dec. 2, 2013 (KR) 10-2013-0148538

(51) Int. Cl. G06T 19/00; G08B 5/00

(52) U.S. Cl. CPC G06T 19/006; G08B 5/00

(57) ABSTRACT

The present invention provides an augmented lane change assistant system using a projection unit. An augmented reality lane change assistant system according to an embodiment of the present invention includes; sensor units that are mounted on a vehicle and obtains driving information of an objective vehicle around the vehicle; a visualizing unit that creates a graphic image by visualizing the driving information; and a projection unit that is disposed in the vehicle and projects the graphic image on a front door window of the vehicle. Accordingly, the driver of the vehicle can intuitionally and more easily know the traffic situation around the vehicle, such that the driver can more quickly check the rear are. Therefore, it is possible to provide a service improved more than lane change assistant systems of the related art and to improve convenience and safety in driving for a driver.

### CROSS-REFERENCE TO RELATED APPLICATION

This application claims the priority benefit of Korean Patent Application No. 10-2013-0148538, filed on Dec. 2, 2013 in the Korean Intellectual Property Office, the disclosure of which is incorporated herein by reference.

### BACKGROUND OF THE INVENTION

1. Field of the Invention

The present invention relates to a lane change assistant system, and more particularly, to an augmented reality lane change assistant system that increases convenience for a driver by projecting a rear image and driving information on a window of a vehicle, using a projection unit.

2. Description of the Related Art

After the IT technology has been introduced for vehicles, vehicles become increasingly smart. In particular, electronic control systems that improve convenience in driving for drivers and increase stability have been continuously complemented and developed and a lane change assistant system is one of them.

A lane change assistant system warns a driver who intends to change a lane while driving, by sensing a vehicle in a lane next to his/her vehicle. For example, lane change assistant systems turn on a warning light when there is a vehicle in a sensing area of a blind spot of an outside mirror such as BSD (Blind Spot Detection) or turn on a warning light when a vehicle approaches a lane change assist area at a high speed such as LCA (Lane Change Assist).

The warning lights of those systems are turned on by a lamp mounted on the outside mirror or are shown on a display mounted on the outside mirror. However, according to the systems of the related art, a driver has to determine a warning situation only from turning-on (a color change) of a warning light and has to frequently look at an outside mirror in order to check the distance and location from an objective vehicle running in a lane next to his/her vehicle. Further, when a lamp is mounted on an outside mirror, a drive may confuse the lamp with another object, and may confuse the lamp with other lights particularly at night.

### SUMMARY OF THE INVENTION

Embodiments of the present invention provide a lane change assistant system that provides a rear traffic situation in augmented reality, using a projection unit, in order that a driver who is driving a vehicle can easily and intuitionally know the rear traffic situation.

An augmented reality lane change assistant system of the present invention includes: sensor units that are mounted on a vehicle and obtains driving information of an objective vehicle around the vehicle; a visualizing unit that creates a graphic image by visualizing the driving information; and a projection unit that is disposed in the vehicle and projects the graphic image on a front door window of the user's vehicle.

The system may further include an electronic control unit that controls operation of the sensor units, the visualizing unit, and the projection unit.

The sensor units each may include an ultrasonic sensor or a radar sensor mounted on a side or the rear of the vehicle and may transmit and receive ultrasonic waves or radio waves to and from the objective vehicle at a predetermined period.

The sensor units each may further include a signal processing unit calculating the driving information of the objective vehicle by performing signal processing on signal information obtained by the ultrasonic sensor or the radar sensor.

The driving information of the objective vehicle may include speed information and location information of the objective vehicle and distance information between the vehicle and the objective vehicle.

The projection unit may include a projector that radiates a beam of the graphic image forward and a reflecting mirror that reflects the beam radiated from the projector to be projected on the front door window and the size of the projected graphic image may be adjusted by adjusting the angle of the reflecting mirror.

The visualizing unit may create the graphic image, including an informing image for informing a driver of the vehicle that the objective vehicle was sensed by the sensing units.

Embodiments of the present invention provide augmented reality overlapping an image on an outside mirror by projecting a graphic image, which visualizes the driving information of an objective vehicle in the side rear area from a vehicle, on a window of the vehicle, such that the driver can intuitionally and more easily know the traffic situation around the vehicle, and accordingly, the driver can more quickly check the rear area. Therefore, it is possible to provide a service improved more than lane change assistant systems of the related art and to improve convenience and safety in driving for a driver.

### BRIEF DESCRIPTION OF THE DRAWINGS

FIG. 1 is a plan view showing a vehicle equipped with an augmented reality lane change assistant system according to an embodiment of the present invention.

FIG. 2 is a block diagram schematically showing an augmented reality lane change assistant system according to an embodiment of the present invention.

FIGS. 3 and 4 are views showing an example of operation of the augmented reality lane change assistant system of FIG. 2.

FIGS. 5 and 6 are views showing an example of a projection image, when an objective vehicle is in a viewing range of an outside mirror of a vehicle.

FIGS. 7 and 8 are views showing an example of a projection image, when an objective vehicle is in a blind spot range of an outside mirror of a vehicle.

### DETAILED DESCRIPTION OF THE PREFERRED EMBODIMENTS

Hereinafter, embodiments of the present invention will be described in detail with reference to the accompanying drawings.

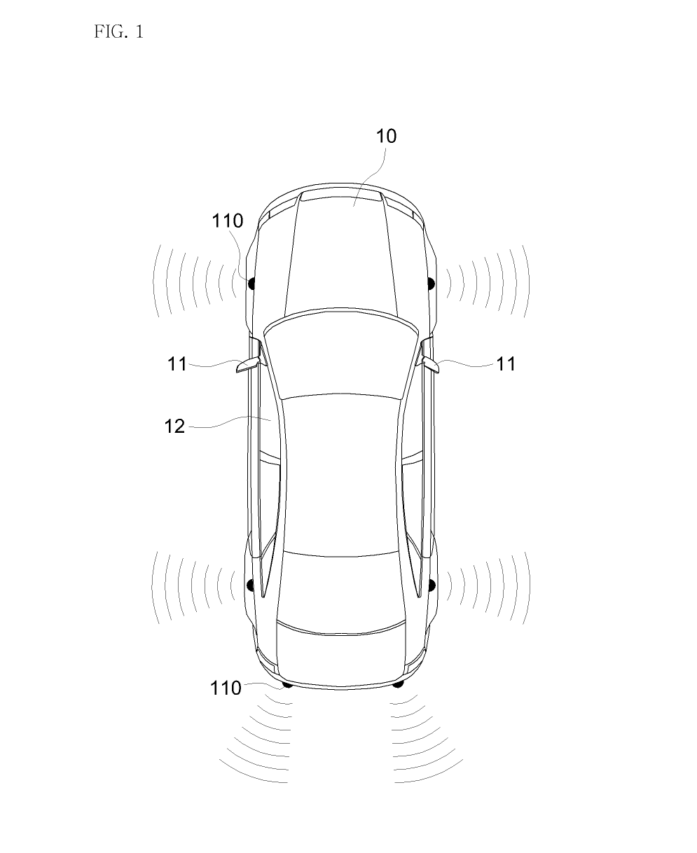

FIG. 1 is a plan view showing a vehicle equipped with an augmented reality lane change assistant system according to an embodiment of the present invention.

Referring to FIG. 1, an outside mirror 11 enabling a driver to see the rear area is mounted on both sides of a vehicle 10.

A front door window 12 is mounted on the doors at both sides of the driver's sheet.

Sensor units 110 composed of a plurality of sensors are mounted on the sides and the rear of the vehicle 10.

The sensor units 110 obtain driving information of an objective vehicle running in a lane next to the vehicle 100 to improve convenience and stability in driving for a driver. This will be described in detail below.

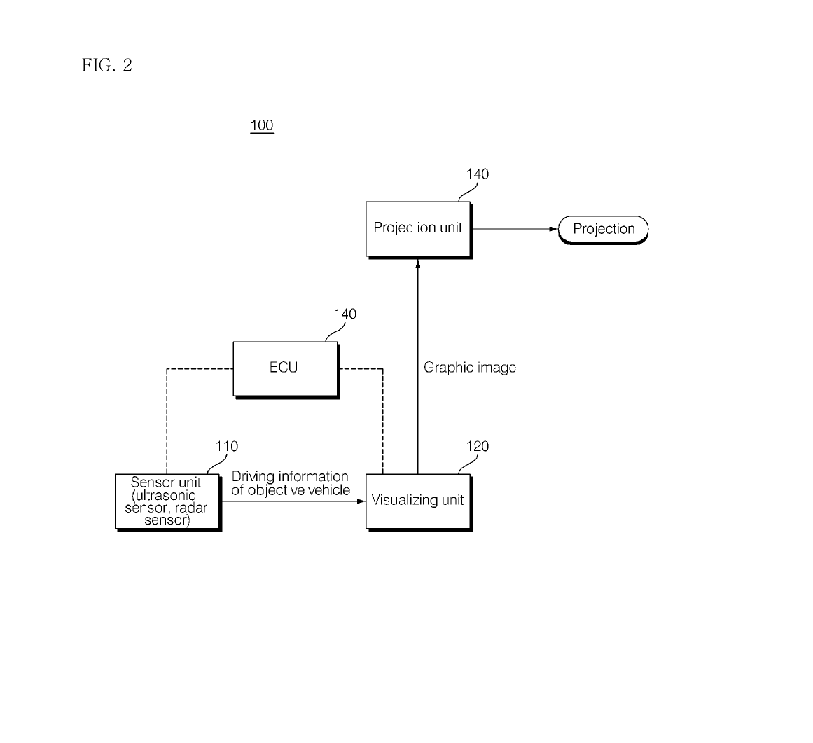

FIG. 2 is a block diagram schematically showing an augmented reality lane change assistant system 100 (hereafter, referred to as a lane change assistant system) according to an embodiment of the present invention.

Referring to FIG. 2, the lane change assistant system 100 includes a sensing unit 110, a visualizing unit 120, and a projection unit 130.

The lane change assistant system 100 may further include an ECU (Electronic Control Unit) 140 controller the sensor unit 110, the visualizing unit 120, and the projection unit 130. The ECU 140 is a well-known component for controlling electronic devices and modules, so the detailed description is not provided.

The sensor unit 110 is mounted on a vehicle 10 (see FIG. 1) and obtains driving information of an objective vehicle around the vehicle. In this specification, the term ‘objective vehicle’ means a vehicle running in a lane next to the vehicle 10, particularly, a vehicle running at a side behind the vehicle or in a blind spot.

The sensor unit 110 may include an ultrasonic sensor or a radar sensor. That is, an ultrasonic sensor and a radar sensor may be both or selectively mounted on a vehicle. The ultrasonic sensor and the radar sensor send out ultrasonic waves or radio waves to an objective vehicle and receive them at a predetermined period.

The sensor unit 110 may further include a signal processor (not shown) that calculates driving information of an objective vehicle by performing signal processing on signal information obtained by the ultrasonic sensor or the radar sensor.

The ‘driving information of an objective vehicle’ includes speed information and location information of the objective vehicle and the distance information between the vehicle 10 and the objective vehicle, but is not limited thereto.

The speed information of an objective vehicle says the speed of the objective vehicle and the location information of an objective vehicle says where the objective vehicle is from the vehicle 10. The distance information between the vehicle 10 and the objective vehicle says the distance between the vehicle 10 and the objective vehicle.

Obtaining the speed of an objective vehicle, using an ultrasonic sensor or a radar sensor can be achieved by well-known methods, so the detailed description is not provided.

For example, the ultrasonic sensor of the sensor unit 110 sends out ultrasonic waves (radio waves) to an objective vehicle and receives it at a predetermined period and can calculate the distance from the objective vehicle from the time until the ultrasonic waves sent out from the ultrasonic sensor is received.

It is possible to know the position where the objective vehicle is from the vehicle 10 by generalizing the signals received a plurality of ultrasonic sensors and it is also possible to estimate the speed of the objective vehicle by generalizing the speed of the vehicle and the location information of the objective vehicle.

The visualizing unit 120 creates a graphic image by visualizing the driving information of an objective vehicle obtained by the sensor unit 110.

The ‘graphic image’ means an image created by processing data into a graph or an image fitting the object. Visualizing the driving information of an objective vehicle can be achieved by well-known methods, so the detailed description is not provided.

For example, the visualizing unit 120 may include an image processing module, a graphic mapping module, and a graphic image rendering module. The visualizing unit 120 keeps various image resources and can select an image resource suitable for showing the driving information of an objective vehicle and create a layout on a screen. Further, it is possible to visualize the driving information of an objective vehicle so that a driver can intuitionally recognize it by outputting a layout through a display device.

A graphic image is projected on a front door window 12 (see FIG. 1) of the vehicle 10 by the projection unit 130 to be described below and this will be described below with reference to other figures.

The projection unit 130 projects a graphic image created by the visualizing unit 120 on a front door window 12 (see FIG. 1) of the vehicle 10.

The projection unit 130 may be disposed inside the vehicle 10 so that it can project graphic images on a front door window 12.

For example, the projection unit 130 may project an image on a left front door window 12 and the right front door window 13 with respect to the running direction of the vehicle(a user's vehicle) 10. To this end, two or more projection units 130 may be provided. The projection unit 130 will be described below in detail with reference to other figures.

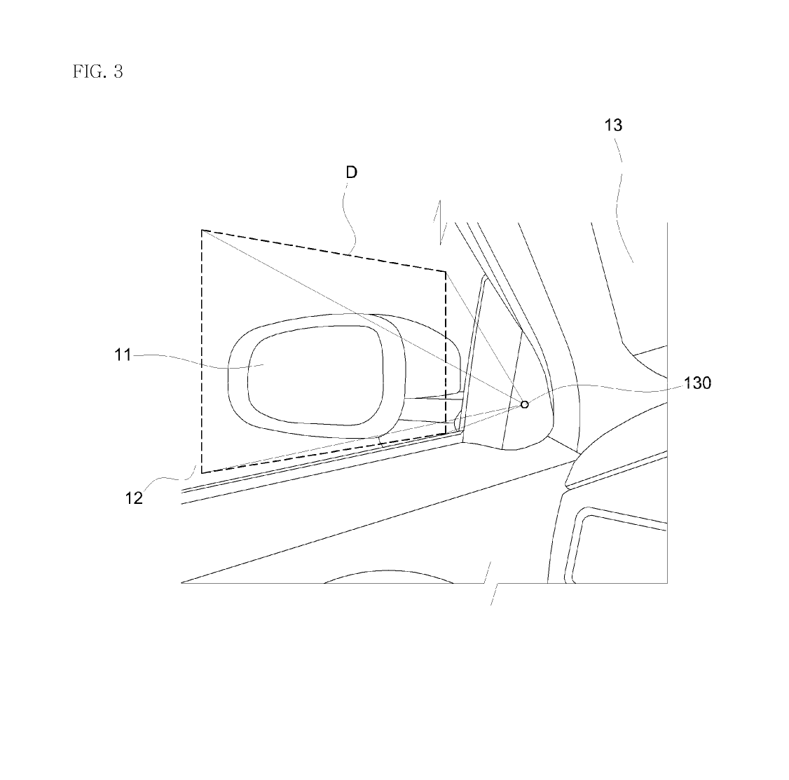

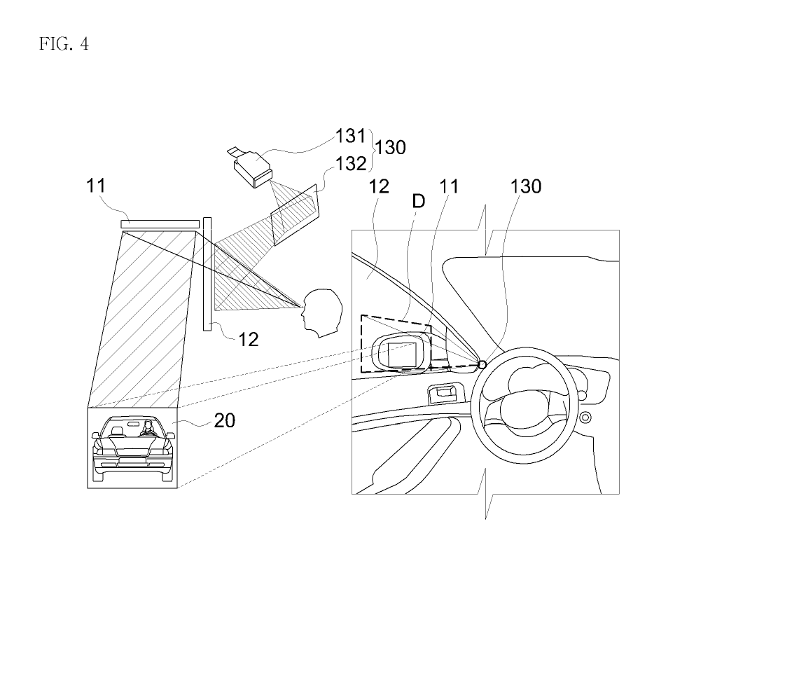

FIGS. 3 and 4 are views showing an example of operation of the augmented reality lane change assistant system 100 of FIG. 2. FIG. 3 shows a graphic image projected on the front door window 12 of the vehicle 10 by the projection unit 130 and FIG. 4 shows the concept of the projection.

Referring to FIG. 3, a driver can see the side rear area from the vehicle 10 which is shown on the outside mirror 11 through the front door window 12, when the system is not operated. In particular, the driver repeatedly looks at the outside mirror for a short time to check whether there is an objective vehicle in the side rear area from the vehicle 10 and the distance from an objective vehicle, when he/she tries to change the lane.

According to the lane change assistant system 100 of the present invention, the visualizing unit 120 (see FIG. 2) visualizes the driving information of an objective vehicle obtained by the sensor unit 110 (see FIG. 2) into a graphic image and the projection unit 130 projects the graphic image on the front door window 12 of the vehicle 10.

When a driver in the vehicle 10 turns his/her eyes to look at the outside mirror 11, he/she sees an image in which the image on the outside mirror 11 and the graphic image overlap each other. The image on the outside mirror 11 shows the side rear area from the vehicle 10 and the graph image shows the driving information of an objective vehicle in the side rear area from the vehicle 10. That is, augmented reality (information made by a computer technology and integrated and displayed in reality) is implemented on the front door window 12 of the vehicle.

Referring to FIG. 4, the projection unit 130 may include a projector 131 that projects forward a beam of graph image visualized by the visualizing unit 120 (see FIG. 2) and a reflecting mirror 132 disposed to reflect a beam from the projector 131 so that it can be projected on the front door window 12.

The projector 131, a device for projecting an image forward, may include a light source (not shown) emitting light, a condensing lens (not shown) condensing light from the light source, a collimating lens changing the light condensed by the condensing lens into parallel light, and a projecting unit projecting an image by radiating the light from the collimating lens. The projector 131 can be selected from the products generally used now, so the detailed description is not provided.

The projector 131 receives and projects a graphic image created by the visualizing unit 120 (see FIG. 2). The projector 131 may be disposed inside a front-side panel in the vehicle 10 and may be installed at various positions in various types on the assumption that it can project an image on the front door window 12 of the vehicle 10.

The reflecting mirror 132 reflects the light (beam) emitted from the projector 131 so that it is projected on the front door window 12. The reflecting mirror 132 is disposed at a predetermined distance ahead of the projector 131 and may be disposed at an angle so that the light emitted from the projector 131 can be projected on the front door window 12. The reflecting mirror 132 may not be provided, but when the reflecting mirror 132 is provided, the light (beam) emitted from the projector 131 can be enlarged into a size suitable for a driver to see it, because the distance between the projector 131 and the front door window 12 is relatively short.

The size of the graphic image projected from the projector 131 may be changed by adjusting the angle of the reflecting mirror 132. For example, it may be possible to project a graphic image on the entire area of the front door window 12 by adjusting the angle of the reflecting mirror 132.

That is, when there is an objective vehicle 20 in the side rear area from the vehicle 10, the objective vehicle 20 is reflected in the outside mirror 11 of the vehicle 10. The driver of the vehicle 10 checks the objective vehicle 20 reflected in the outside mirror 11 through the front door window 12.

The sensor units 110 (see FIG. 2) on the sides and the rear of the vehicle 10 obtain the driving information of the objective vehicle 20. The visualizing unit 120 (see FIG. 2) visualizes the driving information of the objective vehicle 20 into a graphic image.

The projector 131 in the vehicle 10 projects the graphic image forward. The reflecting mirror 132 disposed ahead of the projector 131 reflects the graphic image to the front door window 12 of the user' vehicle 10 to be projected (D). Accordingly, the driver can check the objective vehicle 20 in the outside mirror 11 through the front door window 12 and the projected graphic image. The graphic image shows the driving information of the objective vehicle 20, so augmented reality is implemented and the driver can more intuitionally know the traffic situation in the rear area.

Hereinafter, the graphic image is further described.

In the lane change assistant system 100 according to an embodiment of the present invention, the graphic image visualized by the visualizing unit 120 (see FIG. 2) includes an informing image for informing the driver of the vehicle 10 that an objective vehicle 20 (see FIG. 4) was sensed. The graphic image may further include the location relationship between the image of the vehicle 10 and the image of the objective vehicle 20. Further, the graphic image may further include a text saying the speed of the objective vehicle 20. The informing image, the image of the vehicle 10, and the image of the objective vehicle 20 may be selected from the image resources that are stored in advance in the visualizing unit 120 and the visualizing unit 120 creates a graphic image so that the driver can more easily know the traffic situation in the area behind the vehicle 10 by appropriately combining the image resources.

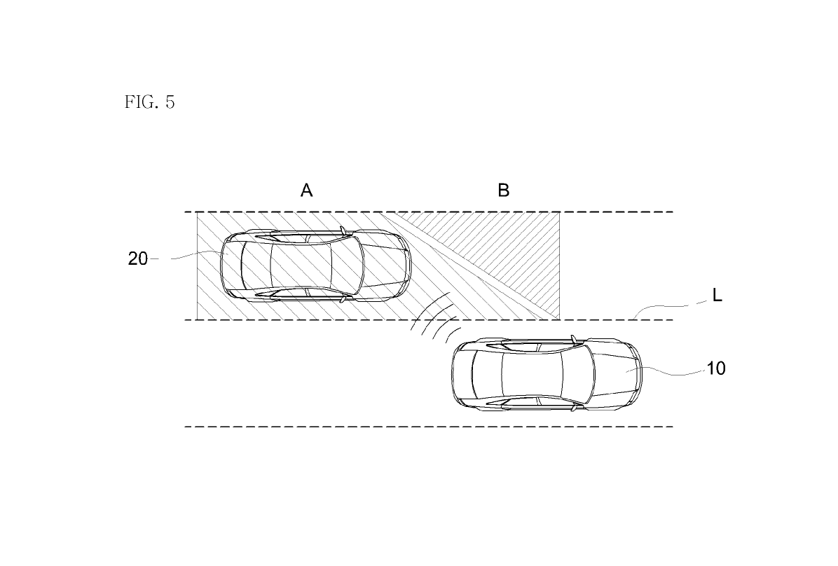

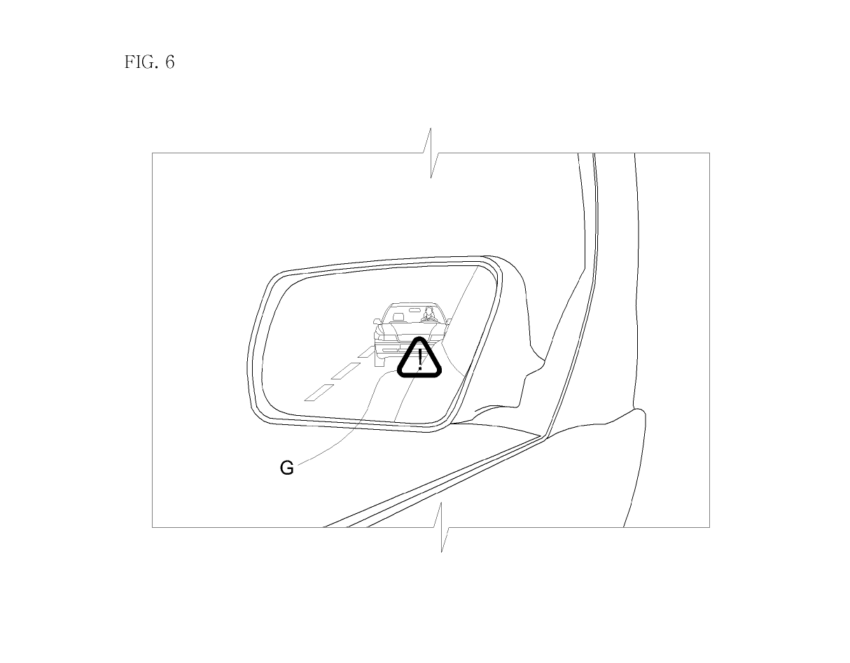

FIGS. 5 and 6 are views showing an example of a projection image when the objective vehicle 20 is in a viewing range A of the outside mirror 11 of the vehicle.

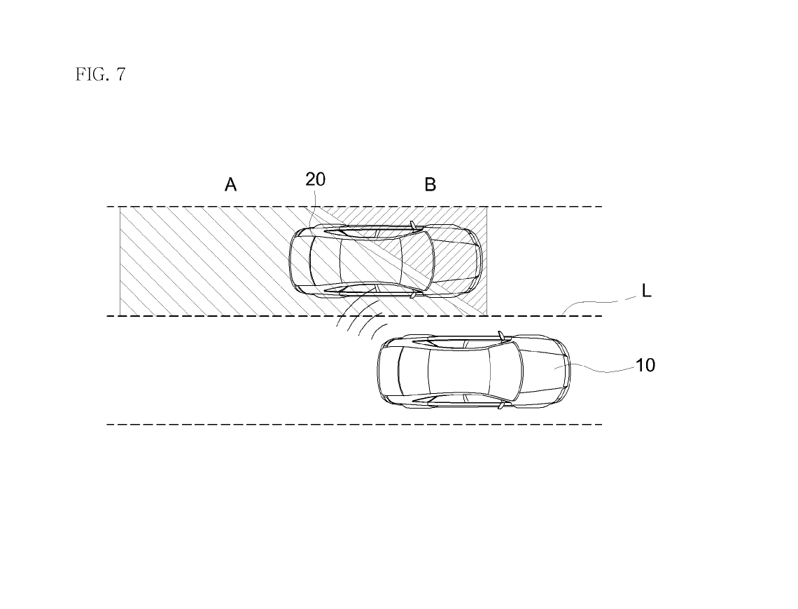

Referring to FIGS. 5 to 8, the outside mirror 11 has a viewing range A and a blind spot B. The viewing range A means a range A in which the objective vehicle 20 in the side rear area from the vehicle 10 is reflected in the outside mirror 11 (see FIG. 5) and the blind spot B means a range B in which the objective vehicle 20 is positioned close to or beyond the outside mirror 11 and is not reflected in the outside mirror 11 (see FIG. 7). The symbol ‘L’ shown in FIGS. 5 and 7 indicates a lane.

When the objective vehicle 20 is within the viewing range A, a graphic image G projected on the front door window 12 of the vehicle 10 by the projection unit 130 may show an informing image.

For example, FIG. 6 shows an example when an image of a triangle with ‘!’ therein is projected to inform the driver that there is the objective vehicle 20. Obviously, this is just an example and the informing image may be created with various images or colors.

When the objective vehicle 20 is within the viewing range A, the driver has only to know that there is the objective vehicle and other information is relatively less important, so only the information images may be projected.

When the objective vehicle 20 is within the blind spot B, it is a dangerous situation more than the case when the objective vehicle is within the viewing range A. This is because when the objective vehicle 20 is within the blind spot B, the possibility of an accident when the vehicle 10 changes the lane is large. In this case, the graphic image G projected on the front door window 12 of the vehicle 10 by the projection unit 130 may be added in various types other than the informing image.

For example, the graphic image G shows the location relationship between the image of the vehicle 10 and the image of the objective vehicle 20, and in addition, shows an estimated speed of the objective vehicle 20, or a warning image for warning the driver of the vehicle 10 may be added. Those images may be simultaneously shown, when the objective vehicle 20 is within the blind spot B.

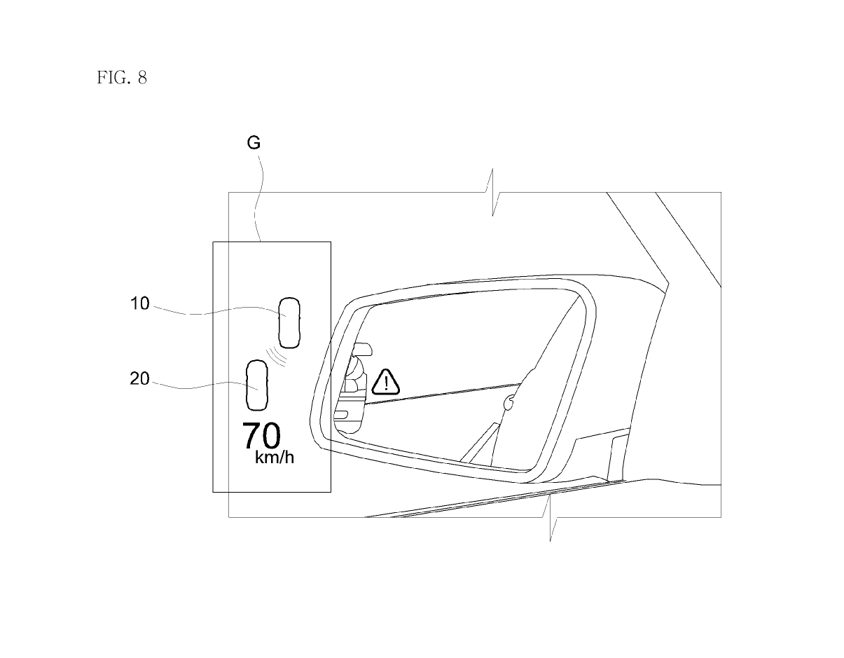

Further, FIG. 8 shows the location relationship between the vehicle 10 and the objective vehicle 20, at the left side in the graphic image G, in which the speed of the objective vehicle 20 is shown by a text under the location relationship. The user's vehicle 10 and the objective vehicle 20 may be discriminated by using different colors or icons. A specific warning image is shown in the space where the graphic image G and the outside mirror 11 overlap each other. Obviously, this is just an example and the items of information may be visualized by using various images or colors. When the objective vehicle 20 is within the blind spot B, the driver needs to know the driving information of the objective vehicle 20 in more detail. Accordingly, it is possible to improve convenience and stability in driving for the driver by showing more information, as compared with when the objective vehicle 20 is within the viewing range A.

As described above, embodiments of the present invention provide augmented reality overlapping an image on an outside mirror by projecting a graphic image, which visualizes the driving information of an objective vehicle at a side of a vehicle, on a window of the vehicle, such that the driver can more easily intuitionally know the traffic situation in the side rear area from the vehicle. Accordingly, the driver can more quickly check the rear area, so it is possible to provide a service improved more than lane change assistant systems of the related art and to improve convenience and safety in driving for a driver.

Although embodiments of the present invention were described above, those skilled in the art can change and modify the present invention in various ways by adding, changing, or removing components without departing from the spirit of the present invention described in claims and those changes and modifications are included in the scope of the present invention.

What is claimed is:

1. An augmented reality lane change assistant system comprising:
sensor units that are mounted on a vehicle and obtains driving information of an objective vehicle around the vehicle;
a visualizing unit that creates a graphic image by visualizing the driving information; and
a projection unit that is disposed in the vehicle and projects the graphic image on a front door window of the vehicle.

2. The system of claim 1, further comprising an electronic control unit that controls operation of the sensor units, the visualizing unit, and the projection unit.

3. The system of claim 1, wherein the sensor units each include an ultrasonic sensor or a radar sensor mounted on a side of the vehicle.

4. The system of claim 3, wherein the sensor units are disposed on the sides or the rear of the vehicle.

5. The system of claim 3, wherein the sensor units transmit and receive ultrasonic waves or radio waves to and from the objective vehicle at a predetermined period.

6. The system of claim 3, wherein the sensor units each further include a signal processing unit calculating the driving information of the objective vehicle by performing signal processing on signal information obtained by the ultrasonic sensor or the radar sensor.

7. The system of claim 6, wherein the driving information of the objective vehicle includes speed information and location information of the objective vehicle and distance information between the vehicle and the objective vehicle.

8. The system of claim 1, wherein the projection unit includes a projector that radiates a beam of the graphic image forward and a reflecting mirror that reflects the beam radiated from the projector to be projected on the front door window.

9. The system of claim 8, wherein the size of the projected graphic image is adjusted by adjusting the angle of the reflecting mirror.

10. The system of claim 1, wherein the visualizing unit creates the graphic image, including an informing image for informing a driver of the vehicle that the objective vehicle was sensed by the sensing units.

11. The system of claim 10, wherein the visualizing unit creates the graphic image, further including the location relationship between an image of the vehicle and an image of the objective vehicle.

12. The system of claim 10, wherein the visualizing unit creates the graphic image, further including a text saying the speed of the objective vehicle.

13. The system of claim 10, wherein the visualizing unit creates the graphic image, further including a warning image for warning the driver of the vehicle, when the objective vehicle is in or close to a blind spot of the outside mirror of the vehicle.

14. The system of claim 11, wherein the visualizing unit creates the graphic image simultaneously including the location relationship, the warning text, and the warning image, when the objective vehicle is in or close to the blind spot of the outside mirror of the vehicle.

15. A method of operating an augmented reality lane change assistant system, the method comprising:
obtaining driving information of an objective vehicle running in a next lane from sensor units;
creating a graphic image by visualizing the driving information of the objective vehicle obtained by the sensor units; and
projecting the graphic image on a front door window.

16. The method of claim 15, wherein the driving information of the objective vehicle includes speed information and location information of the objective vehicle and distance information between the vehicle and the objective vehicle.

17. The method of claim 15, wherein in the obtaining of driving information, the sensor units mounted on the sides and the rear of the vehicle obtain the driving information of the objective vehicle by transmitting and receiving ultrasonic waves or radio waves to and from the objective vehicle.

18. The method of claim 15, wherein the projecting further includes adjusting the size of the graphic image by adjusting the angle of a reflecting mirror.

19. The method of claim 15, wherein the creating of a graphic image creates the graphic image including at least any one of an informing image for informing a driver the vehicle that the objective vehicle was sensed, a location relationship between an image of the vehicle and an image of the objective vehicle, and a text saying the speed of the objective vehicle.

20. The method of claim 15, wherein the creating of a graphic image creates the graphic image including at least any one of a warning image for warning the driver of the vehicle, when the objective vehicle is in or close to a blind spot of an outside mirror of the vehicle, a location relationship with the objective vehicle, and a warning text.
